(19) United States
(12) Patent Application Publication
(10) Pub. No.: US 2020/0093683 A1
(43) Pub. Date: Mar. 26, 2020

(54) DEVICES AND METHODOLOGIES FOR PHYSICAL THERAPY AND WELL BEING

(71) Applicants: Cosmo Mark Raines, Austin, TX (US); Christie Powell, Austin, TX (US)

(72) Inventors: Cosmo Mark Raines, Austin, TX (US); Christie Powell, Austin, TX (US)

(21) Appl. No.: 16/527,011

(22) Filed: Jul. 30, 2019

Related U.S. Application Data
(63) Continuation-in-part of application No. 14/217,421, filed on Mar. 17, 2014, now Pat. No. 10,363,195.
(60) Provisional application No. 61/786,399, filed on Mar. 15, 2013.
(60) Provisional application No. 61/786,468, filed on Mar. 15, 2013.
(60) Provisional application No. 61/802,040, filed on Mar. 15, 2013.

(51) Int. Cl. A61H 15/00

(52) U.S. Cl. CPC A61H 15/0092; A61H 2015/0035; A61H 2201/0107; A61H 2201/0192; A61H 2015/005

(57) ABSTRACT

A device for use in physical therapy is provided. The device includes an axis, and a plurality of rollers which are rotatably mounted on the axis. Each roller is equipped with a shaft through which the axis extends. The surface of the shaft is equipped with a plurality of spaced apart protrusions, and an adjustable locking feature disposed on the axis that rotatably and releasably engages the grooves formed by the spaces between the protrusions such that the distance between the rollers may be adjustably fixed to any of a plurality of predetermined values.

### CROSS-REFERENCE TO RELATED APPLICATIONS

This application is a continuation-in-part application which claims the benefit of priority from U.S. application Ser. No. 14/217,421, filed Mar. 17, 2014, having the same inventors, and which is incorporated herein by reference in its entirety; which application claims the benefit of U.S. Provisional Application No. 61/786,399, filed Mar. 15, 2013, having the same title, and which is incorporated herein by reference in its entirety; and also claims the benefit of U.S. Provisional Application No. 61/786,468, filed Mar. 15, 2013, which is incorporated herein by reference in its entirety; and also claims the benefit of priority of U.S. Provisional Application No. 61/802,040, filed Mar. 15, 2013, which is incorporated herein by reference in its entirety.

### FIELD OF THE DISCLOSURE

The present disclosure relates generally to physical therapy, and more particularly to devices which are useful in physical therapy and to methods for using the same.

### BACKGROUND OF THE DISCLOSURE

Various devices have been developed for use in physical therapy, or as accessories for use in physical exercise or training. Many of these devices are limited to a specific use or effect. Consequently, physical therapists are required to maintain a wide variety of these devices in order to accommodate the different needs of their clientele, and are also required to invest time in learning how to use each of these tools for its intended purpose. As a practical matter, it is difficult and expensive for a physical therapist to maintain and use such a wide range of tools directed to different uses or effects.

### BRIEF DESCRIPTION OF THE DRAWINGS

The devices and methodologies disclosed herein may be further appreciated with respect to the particular, non-limiting embodiments disclosed in the drawings described below, in which like numerals designate like elements.

FIG. 1 is a perspective view of a first embodiment of a therapeutic device in accordance with the teachings herein.

FIG. 2 is a partially exploded view of the therapeutic device of FIG. 1.

FIG. 3 is a perspective view of the end cap cover of the therapeutic device of FIG. 1.

FIG. 4 is a cross-sectional view taken in a plane along LINE 3-3 of FIG. 3.

FIGS. 5-6 are exploded views of a therapeutic element of the therapeutic device of FIG. 1.

FIG. 7 is a perspective view of the shaft of the therapeutic device of FIG. 1.

FIG. 8 is a cross-sectional view taken along LINE 7-7 of FIG. 7.

FIGS. 9A and 9B are perspective views of a first embodiment of the end cap for the therapeutic device of FIG. 1.

FIGS. 10A and 10B are perspective views of a second embodiment of the end cap for the therapeutic device of FIG. 1.

FIGS. 11A-D are perspective views of a positioning clip for the therapeutic device of FIG. 1.

FIGS. 12A and 12B are side views of the therapeutic device of FIG. 1 which illustrate different placements of the therapeutic elements possible with the device.

FIG. 13 is a perspective view of a second embodiment of a therapeutic device in accordance with the teachings herein.

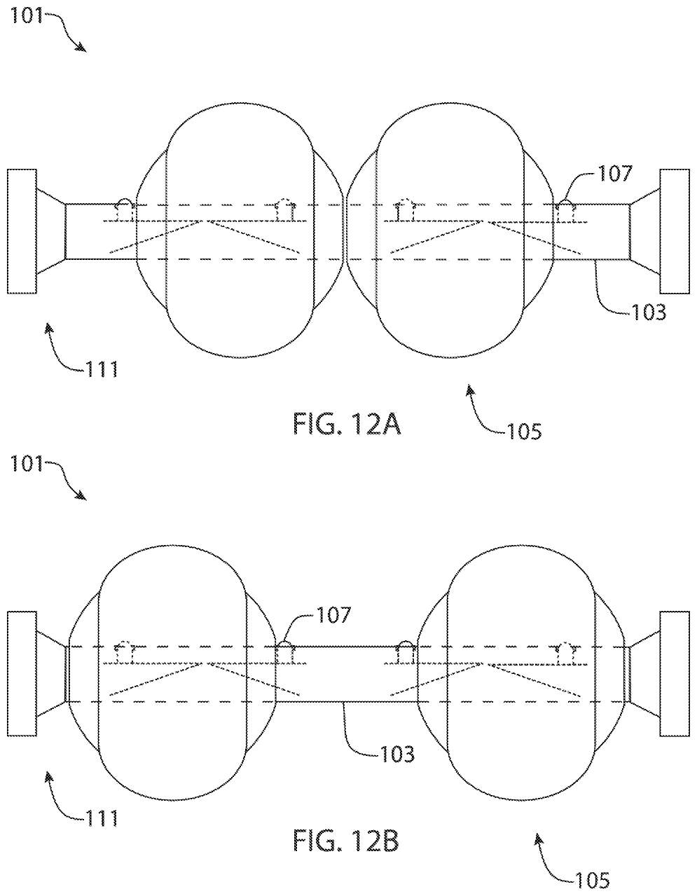

FIG. 14 is a partially exploded view of the therapeutic device of FIG. 13.

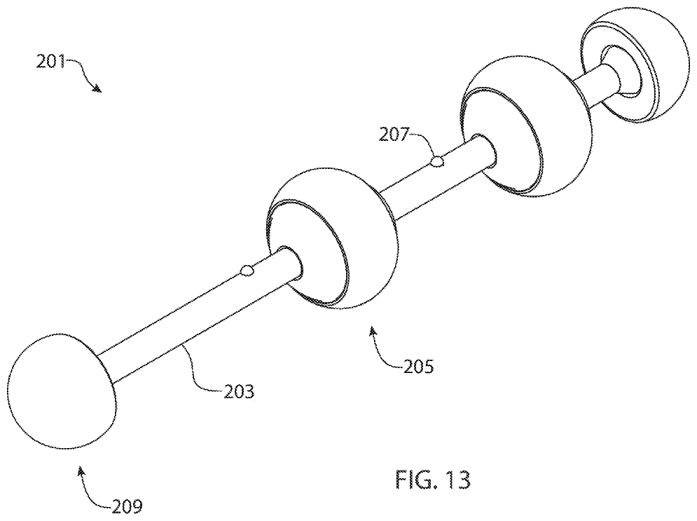

FIGS. 15A-D are side views of the therapeutic device of FIG. 13 which illustrate different placements of the therapeutic elements possible with the device.

FIG. 16A is a side view of a therapeutic element of a therapeutic device in accordance with the teachings herein.

FIG. 16B is a side view, partially in section, of the therapeutic device of FIG. 16A.

FIGS. 17A-E are side views, partially in section, of different embodiments of bands for the therapeutic element of FIG. 16A.

### SUMMARY OF THE DISCLOSURE

In one aspect, a therapeutic device is provided which comprises (a) a first shaft element which releasably couples with a second shaft element to provide a shaft of adjustable length; and (b) a plurality of therapeutic elements rotatably mounted on said shaft.

In another aspect, a device is provided which is useful in physical therapy. The device comprises (a) a handle equipped with a first connector; and (b) a roller which is releasably attached to said handle by way of said first connector.

In a further aspect, a method for treating soft tissue is provided. The method comprises (a) providing a tool which includes a roller mounted on a handle; (b) using the handle to position the roller against a soft tissue mass; and (c) pressing the roller against the soft tissue mass.

### DETAILED DESCRIPTION

It has now been found that some or all of the foregoing issues may be overcome by the devices and methodologies disclosed herein. In a preferred embodiment, a therapeutic device is disclosed herein for use in physical therapy or well-being. In some embodiments, the therapeutic device has a construction that allows different therapeutic elements (which may be accessories, surfaces or attachments) to be readily added to, or removed from, the therapeutic device, and each of these elements may be directed to a specific use or effect. In other embodiments (which may be the same as, or different from, the foregoing embodiments), the arrangement of elements on the device may be readily reconfigured without disassembling the device. For example, the device may be adjusted from a first configuration to a second configuration to render it more suitable for the next anticipated use. Consequently, a user or physical therapist may use the therapeutic devices disclosed herein, preferably in conjunction with a variety of such therapeutic elements, for a wide range of applications, and the learning curve for these disparate uses may be minimized. Similarly, the configuration of the therapeutic elements on the device may be readily modified without disassembling the device, thus allowing a therapist to readily reconfigure the device during use to achieve a particular effect.

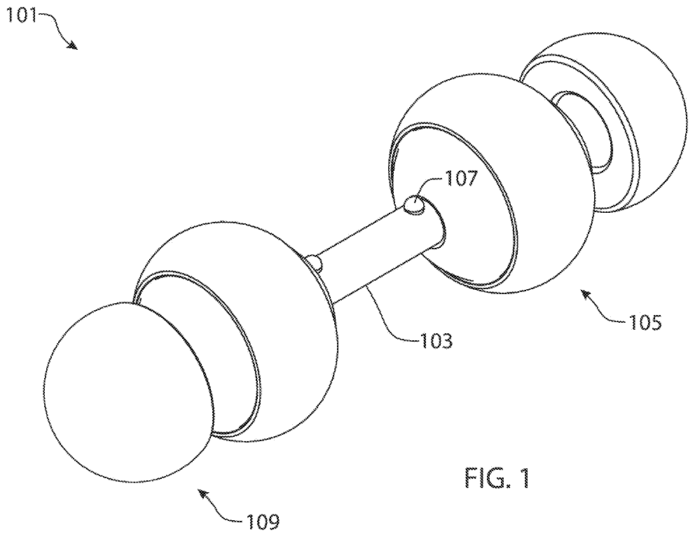

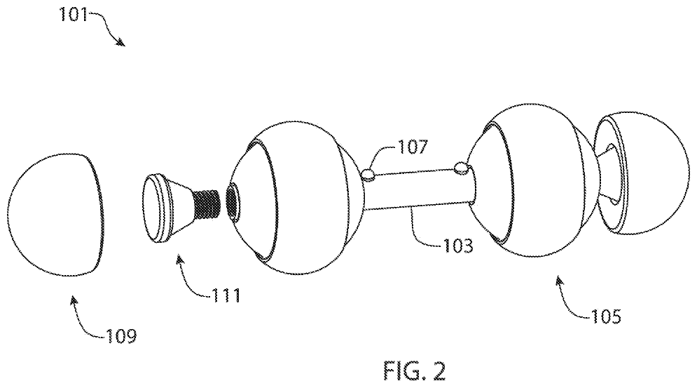

A first particular, non-limiting embodiment of a therapeutic device in accordance with the teachings herein is depicted in FIG. 1. As seen therein, the therapeutic device 101 in this particular embodiment comprises a longitudinal shaft 103 with a plurality of therapeutic elements 105 disposed thereon. The therapeutic elements 105 are preferably generally ellipsoidal in shape and are independently rotatable and repositionable on the shaft 103. The shaft 103 is equipped with first and second end caps 111 (see FIG. 2) disposed on first and second opposing ends thereof. Each of said end caps 111 has an end cap cover 109 disposed thereon.

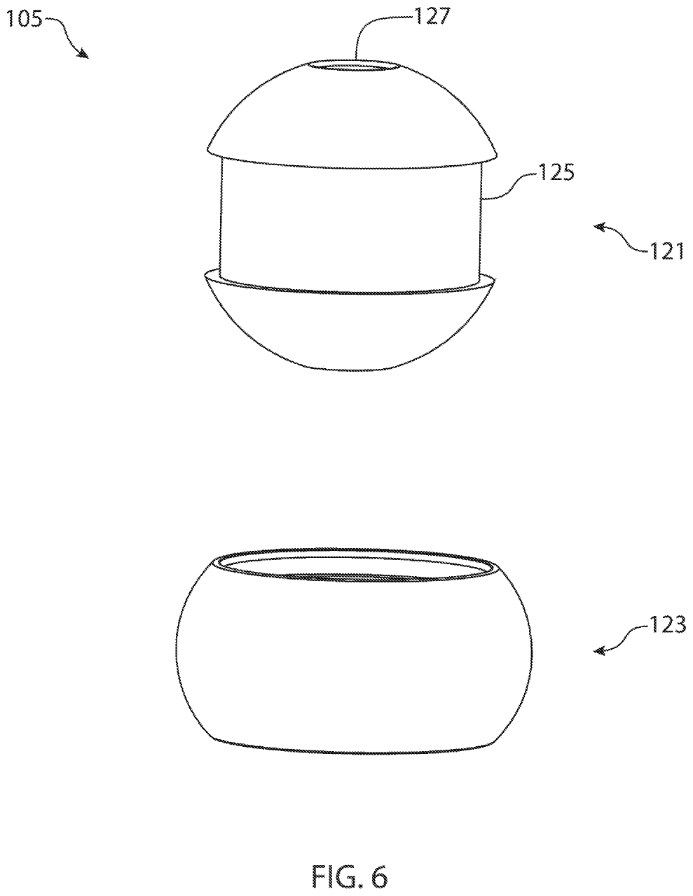

As seen in FIG. 2, the end caps 111 in this particular embodiment (which are shown in greater detail in FIG. 7) have a threaded protrusion 115 on one end which rotatingly engages a threaded aperture at one end of the shaft 103, and a generally bulbous or frustoconical head 117 that releasably engages the end cap cover 109. This construction allows the end caps 111 to be removed as, for example, to remove, replace or add the therapeutic elements 105. In an especially preferred embodiment, the head 117 of the end cap 111 includes a frustum 118 which terminates in an annulus 119, and the annulus may be beveled or tapered on one or both sides.

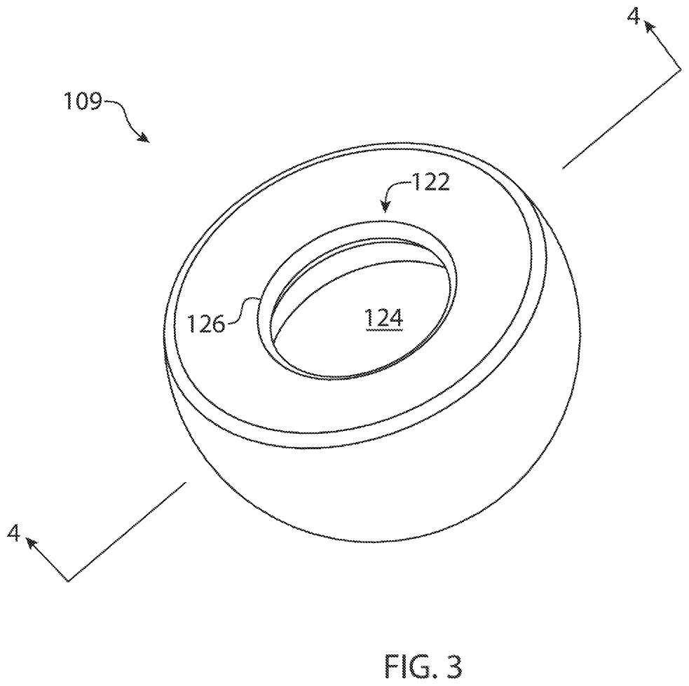

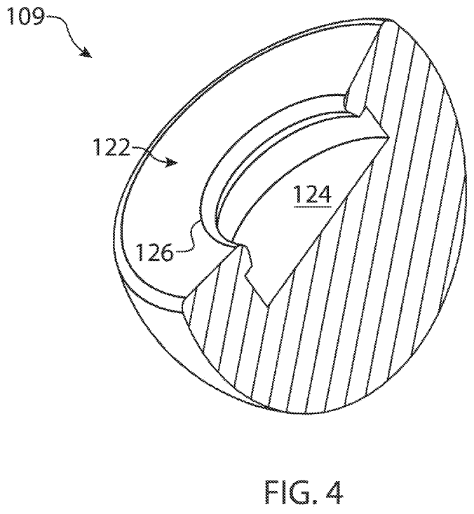

The manner in which the head of each end cap 111 engages the end cap cover 109 may be appreciated with respect to the geometry of the end cap cover 109 as shown in FIGS. 3-4. As seen therein, the end cap cover 109 has a central aperture 122 therein with a bottom 124 having a profile that closely matches the profile of the end cap 111, and a neck 126 that is smaller in diameter than the diameter of the end cap 111 (or more specifically, the annulus 119). Moreover, the end cap cover 109 is preferably fabricated from an elastomeric material such as, for example, a suitable rubber. Consequently, if the end cap 109 is pressed into the central aperture 122 of the end cap cover 111 with sufficient force, the end cap cover 111 will snap into place around the end cap 109. The dimensions of the central aperture 122 with respect to the end cap 109 (or the annulus 119) are preferably chosen so that the end cap cover 109 engages the end cap 111 with sufficient force to prevent the end cap cover 109 from becoming dislodged during normal use, while still allowing it to be removed for maintenance or other purposes.

As seen in FIG. 1, the end cap covers 109 are preferable hemispherical in shape, and preferably comprise a textured, elastomeric material. This shape and texture allow the end cap covers 109 to serve as additional therapeutic elements. This shape also allows the end cap covers 109 to be used to stabilize the therapeutic device 101 on a vertical surface such as a wall. Thus, for example, a user of the therapeutic device 101 may utilize one end cap cover 109 to stabilize the therapeutic device 101 on a wall, while using the opposing end cap cover 109 to probe or manipulate a muscle group.

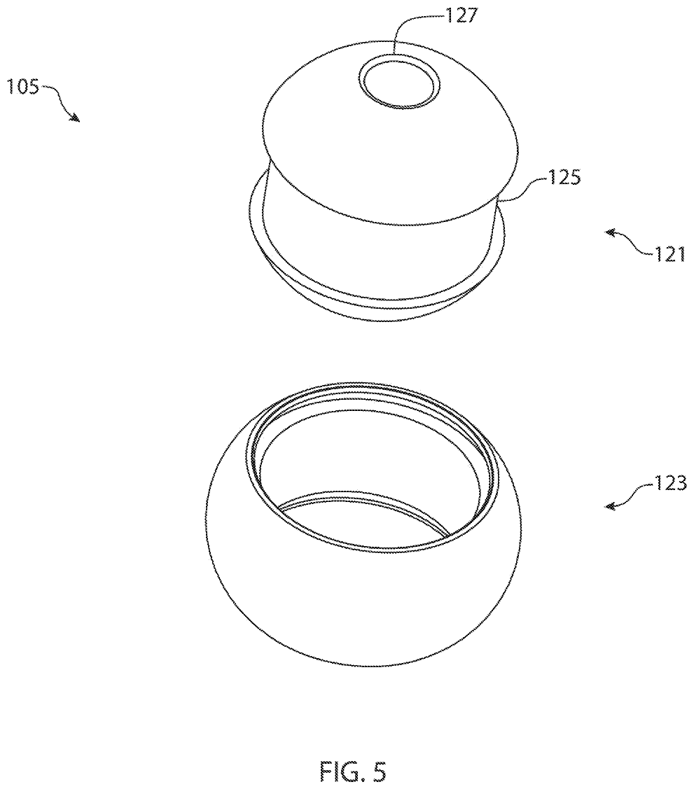

The structure of a preferred embodiment of the therapeutic elements 105 may be further appreciated with respect to FIGS. 5-6. As seen therein, each therapeutic element 105 consists of a base 121 with a (preferably elastomeric) band 123 disposed thereon. The base 121 has a peripheral depression 125 therein in which the band is seated. The base 121 is also equipped with a central aperture 127, which allows it to be mounted on the shaft 103.

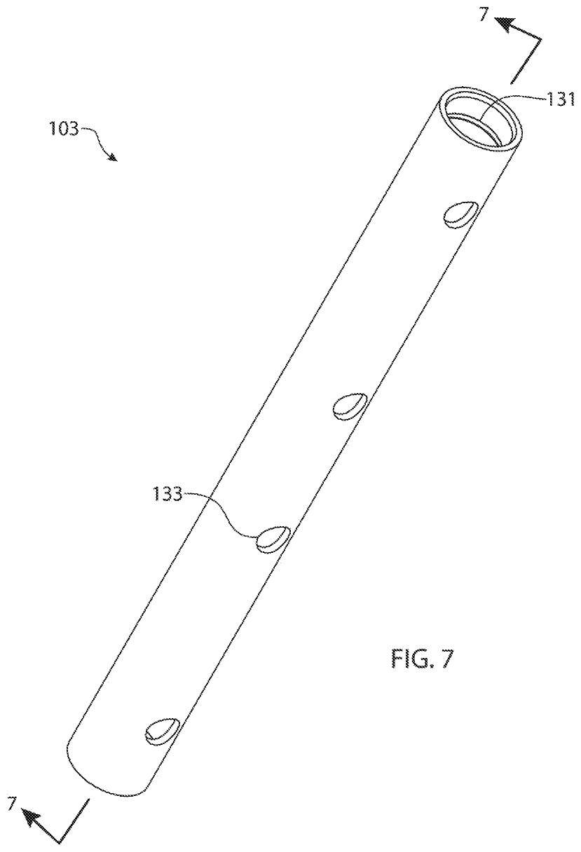

The structure of the shaft 103 may be further appreciated with respect to FIGS. 7-8. As seen therein, in the particular embodiment depicted, the shaft 103 is essentially a hollow, cylindrical rod with a plurality of apertures 133 therein. Each end of the shaft 103 is equipped with internal threading 131 that mates with the threaded protrusions 115 of the end caps 111.

As previously noted, the end caps 111 in the embodiment of FIG. 1 are threaded to permit their removal. However, in some embodiments, it may be preferable to have end caps 111 which are more permanently joined to the shaft 103. This may be the case, for example, in a gym setting where it is desirable for the therapeutic device 101 to be tamper resistant, or simply for safety concerns (e.g., to provide assurance that the end cap 111 will not become dislodged while the therapeutic device 101 is in use).

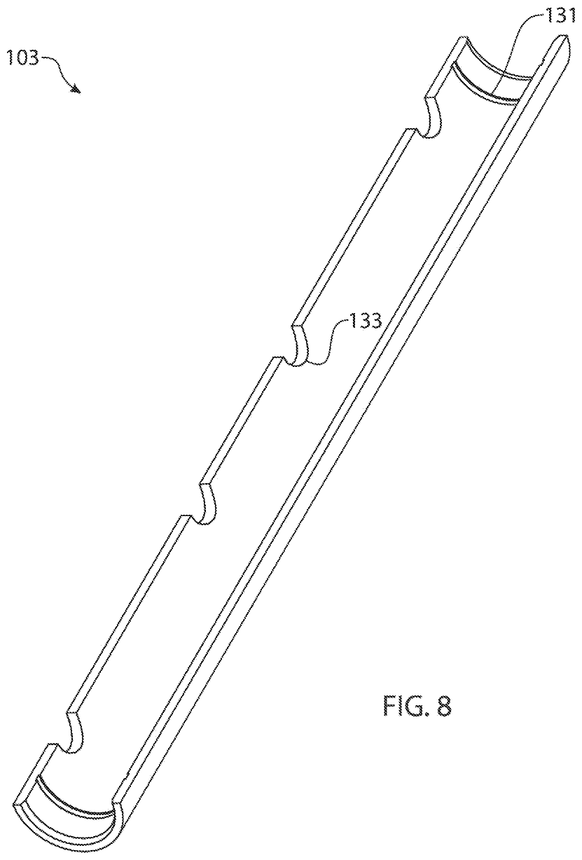

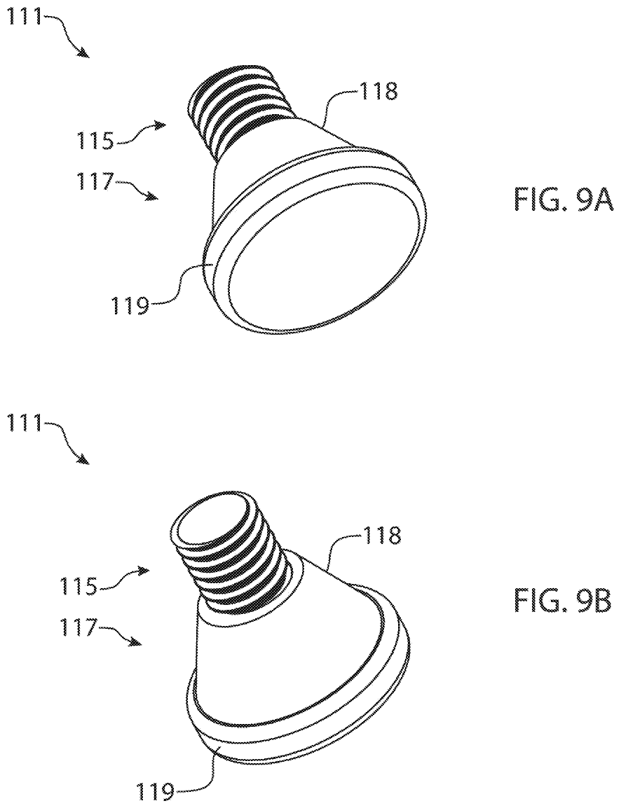

FIG. 10 depicts a particular, non-limiting embodiment of such an end cap. The end cap 111b depicted therein is similar to the end cap 111 of FIG. 9, but differs in that, instead of a threaded protrusion, it is equipped with a press-fit protrusion 115b. This end cap 111b may be driven into place with a rubber mallet or other suitable tool, which causes an annular indentation 132 on the press fitting to permanently engage the threading 131 of the shaft 103.

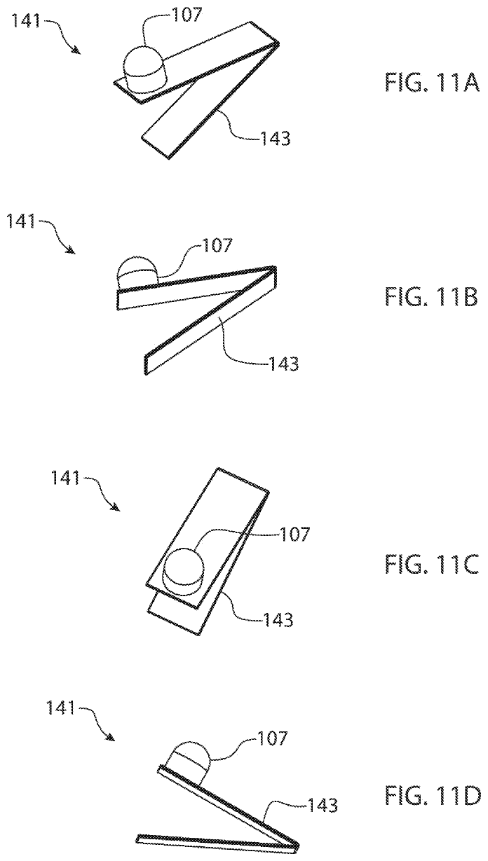

As previously noted, the therapeutic elements 105 are repositionable on the shaft 103. This allows the therapeutic device 101 to be reconfigured into a number of configurations. Thus, for example, as seen in FIG. 12, the therapeutic device 101 can be reconfigured into at least two distinct states. In particular, the therapeutic device 101 can be reconfigured from a first state in which the therapeutic elements 105 are abutting one another (FIG. 12A), to a second state in which the therapeutic elements 105 are spaced apart from each other (FIG. 12B).

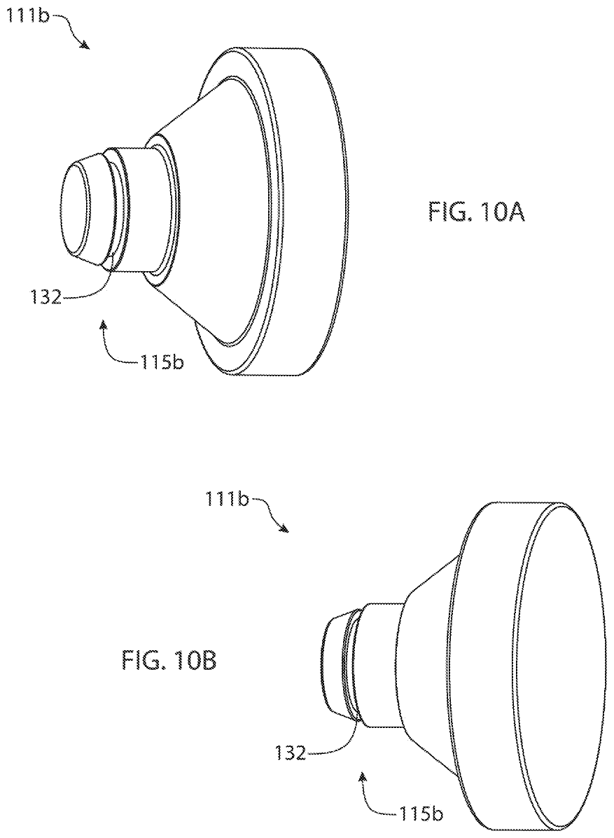

The manner in which the therapeutic elements 105 may be repositioned along the shaft 103 may be appreciated with respect to FIG. 11, which shows the clips 141 (from several vantage points) that are installed within the shaft 103. Each clip 141 has a base portion 143 consisting of a V-shaped spring and a rounded protrusion 107 which is disposed on the base portion. The clip 141 is appropriately sized to fit inside of the shaft 103 such that the rounded protrusion 107 extends through one of the apertures 133 (see FIGS. 7-8) in the shaft 103. Similarly, the spring constant of the base portion 143 is preferably chosen to be within a suitable range such that the rounded protrusion 107 can be depressed with normal finger pressure, but otherwise remains in an extended state in which it maintains one or more of the therapeutic elements 105 within a particular region of the shaft 103 (and preferably in a relatively fixed position on the shaft 103).

In use, when it is desired to reconfigure the therapeutic device 101, the user depresses one of the rounded protrusions 107, which permits the adjacent therapeutic element 105 to move past the protrusion 107 along the shaft 103. After the therapeutic element passes over the protrusion 107, it springs back into place, thus securing the therapeutic element 105 in its new location.

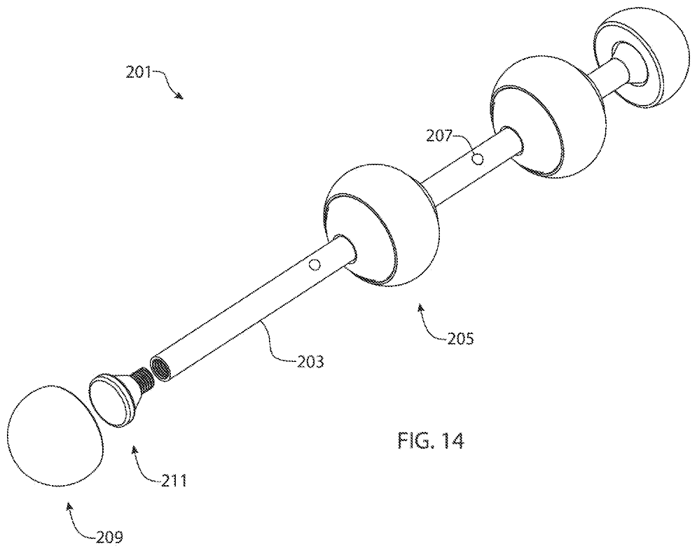

A second particular, non-limiting embodiment of a therapeutic device in accordance with the teachings herein is depicted in FIG. 15. The therapeutic device 201 in this particular embodiment comprises a longitudinal shaft 203 with a plurality of therapeutic elements 205 disposed thereon. The therapeutic elements 205 are generally ellipsoidal in shape and are independently rotatable and repositionable on the shaft 203. The shaft 203 is equipped with first and second end caps 211 of the type depicted in FIG. 9 which are disposed on first and second opposing ends thereof. Each of said end caps 211 has an end cap cover 209 disposed thereon.

The therapeutic device 201 of FIG. 15 is similar in most respects to the therapeutic device 101 of FIG. 1, but has a longer shaft 203. As seen in FIGS. 15A-D, this allows the device to assume at least four different configurations when used with two therapeutic elements 205. Moreover, while the embodiment is depicted with only two therapeutic elements 205, it will be appreciated that the greater length of the shaft 203 in this embodiment permits more therapeutic elements 205 to be mounted on the shaft 203 than was the case with the previous embodiment. Thus, for example, variations including three, four, five or six therapeutic elements 205 mounted on the shaft 203 are possible with this embodiment.

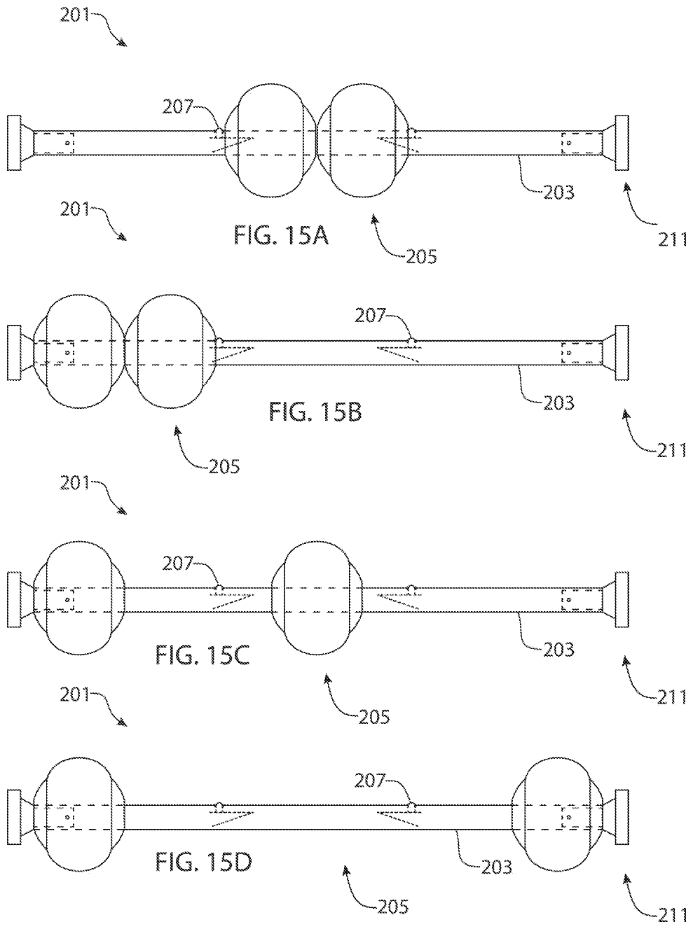

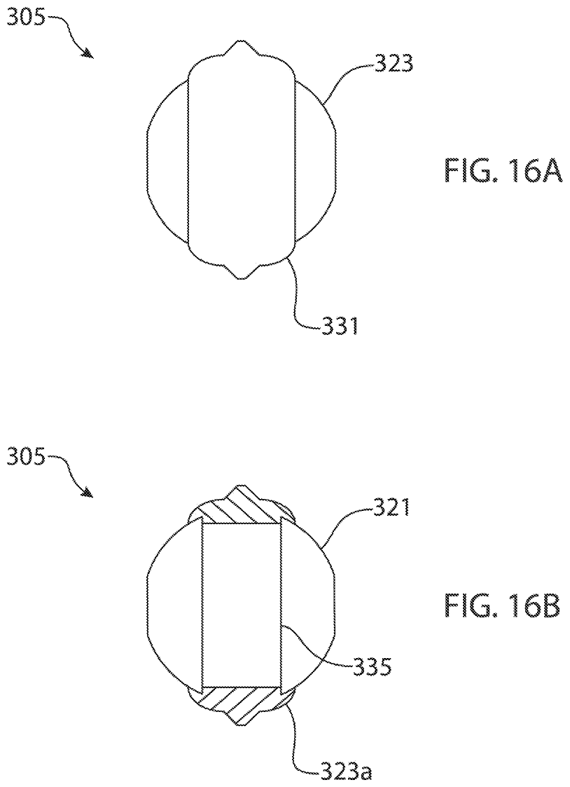

As seen in FIG. 16, in a preferred embodiment, the therapeutic elements 305 are essentially ellipsoidal in geometry, and are equipped with a (preferably central) aperture (not shown, but similar to that depicted in FIG. 5) through which a shaft (see FIG. 2) extends. Each of the therapeutic elements 305 is independently rotatable about the axis of the shaft, and consists of a base 321 having a therapeutic surface 323 disposed thereon. In a preferred embodiment, the therapeutic surface 323 is an elastomeric band which sits in a complimentary-shaped (and preferably central) depression 335 (see, e.g., FIG. 16B) formed in a surface of the base 323.

As explained above, in a preferred embodiment, the therapeutic devices disclosed herein utilize a shaft whose design allows therapeutic elements to be readily added to, or removed from, the shaft, allows the spacing between adjacent therapeutic elements to be adjusted, and allows the therapeutic elements to be rotatably disposed in a fixed position along the length of the shaft. This flexibility allows the therapeutic devices disclosed herein to be readily reconfigured into a wide variety of permutations for various uses. The therapeutic device may be equipped with various numbers of therapeutic elements of various sizes, and each therapeutic element may be equipped with a unique therapeutic surface.

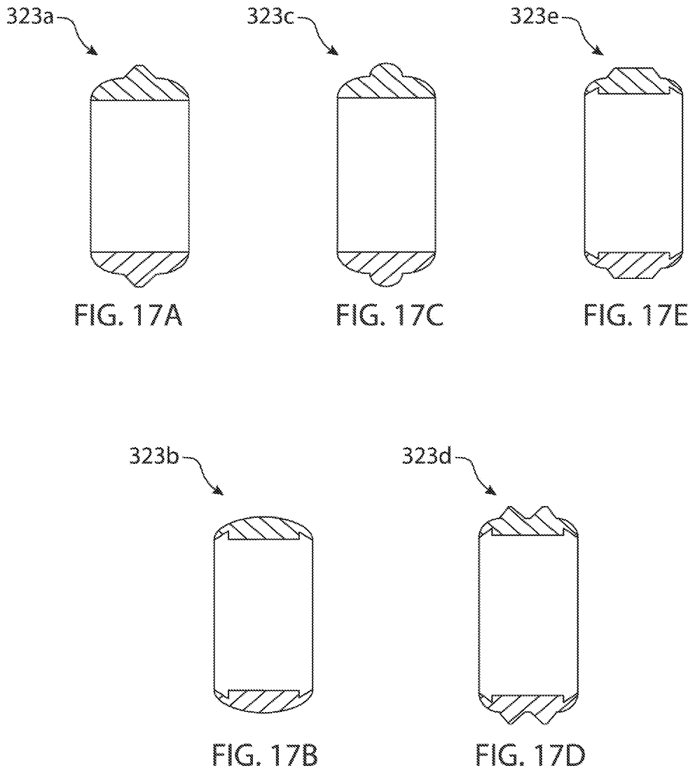

Thus, for example, as seen in FIG. 17, the therapeutic device may be equipped with bands 323 having various surface profiles. Hence, in FIG. 17A, the band 323a has a single, central ridge defined thereon with relatively flat edges. In FIG. 17B, the band 323b has a rounded surface. In FIG. 17C, the band 323c has a single, central ridge defined thereon which has a rounded profile. In FIG. 17D, the band 323d has dual ridges defined thereon, each having relatively flat edges. In FIG. 17E, the band 323e has a single, central ridge defined thereon with a flattened surface and relatively flat edges. It will be appreciated that a variety of other surface profiles are possible, and that the geometries of these profiles may be especially suited for particular therapeutic purposes.

The therapeutic elements disclosed herein may have a variety of textures and profiles, and preferably take the form of balls or rollers. The therapeutic elements may have various densities and may comprise various materials including, for example, wood, metal, glass, plastic, or rubber, although the use of high density foamed rubbers in the therapeutic elements or bands thereof is especially preferred.

As previously noted, in a preferred embodiment, the therapeutic surfaces of the therapeutic device are bands that are removably seatable in a (preferably central) depression provided in the peripheral surface of each therapeutic element. In some embodiments, a plurality of such depressions may be provided, each of which may independently accommodate a separate band or therapeutic surface. Alternatively, a plurality of depressions may be provided in the surface of each therapeutic element, and these depressions may collectively accommodate corresponding protrusions of a single therapeutic surface (e.g., the therapeutic surface may comprise a single band with annular protrusions on an inward facing surface thereof that sit in complimentary shaped depressions on the surface of the base). In still other embodiments, the base may be equipped with a plurality of indentations or apertures which releasably or permanently engage individual therapeutic elements inserted therein.

As previously noted, the therapeutic surfaces preferably take the form of bands of an elastomeric material that can be stretched into place in a complimentary shaped depression formed in the surface of the base, after which the compressive force of the elastomer serves to hold the band in place. Various elastomers may be utilized for this purpose, although the use of silicone and neoprene rubbers is especially preferred. These materials may be compounded with various fillers, pigments or dyes, and may have various textures and colors imparted to their surfaces. These materials may also be presented as closed-cell or open-cell foams.

In some embodiments, one or more of the therapeutic elements may have a monolithic structure. For example, the therapeutic element may comprise a wooded ball without any surface enhancement. In other embodiments, the therapeutic surface may take the form of a surface coating which imparts, for example, a desired texture, grip, resiliency, or warmth to the element.

In some embodiments of the therapeutic devices disclosed herein, a desired therapeutic functionality may be spread across multiple therapeutic elements. Thus, for example, in some embodiments of the therapeutic devices disclosed herein, adjacent therapeutic elements may be spanned by a single therapeutic surface. In such embodiments, each therapeutic element may be equipped with a central, radial depression, and the inward facing surface of the band may be equipped along its opposing edges with radial protrusions that releasably engage the central, radial depressions in the therapeutic elements. It will be appreciated that a similar approach may be utilized to span more than two therapeutic elements, nor is it necessary that the elements are adjacent.

For purposes of brevity, a detailed description of some aspects of the therapeutic devices disclosed herein, such as their use in physical therapy or exercise, has been omitted. However, these details may be found in the following publications produced by the present inventors, all of which are incorporated herein by reference in their entirety:
(a) Dual Ball Thoracic Spine: http://youtu.be/APBjigY7HmA;
(b) Dual Ball Adjustment: http://youtu.be/KrwtQzbk6c8;
(c) General Set-up of MOBO: http://youtu.be/rUQEffSuiHk;
(d) Supine Trapezius Mobilization: http://youtu.be/FYbz5QL_OEc;
(e) Ball & Stick Pec Release/Posterior Rib Mobilization: http://youtu.be/U-qvU8dt3Po;
(f) Dual Ball Suboccipital Release: http://youtu.be/P_oleyK4XoU;
(g) Dual Ball Thoracic Extension III: http://youtu.be/jPYG_zpg3vY;
(h) Dual Ball Thoracic Extension II: http://youtu.be/5Cv7lfGJGSE;
(i) Dual Ball Calf Roll: http://youtu.be/GTwJ8k0RxNQ;
(j) Dual Ball with TRX: http://youtu.be/plxSsQECGZs;
(k) 6 Ball Seated Roller: http://youtu.be/2xZ2Oikdm4I;
(l) 6 Ball Roller ITB/calf: http://youtu.be/be/t2x-_JXoNPI;
(m) MOBO Overview: http://youtu.be/TWQf5Yt0vu4;
(n) MOBO Overview Long: http://youtu.be/j1KuXSWDX-k;
(o) Standing Pec/Middle Trap/Posterior Rib Mobilization: http://youtu.be/SUssVY_Md7s;
(p) Posterior Rib/Middle Trap Mobilization—http://youtu.be/X6Vrtgh14s0;
(q) Hands Free Trap Mobilization—http://youtu.be/CUqmbEKvV5o.

Various modifications may be made to the devices and methodologies disclosed herein without departing from the scope of the present disclosure. For example, the therapeutic elements disclosed herein may assume various sizes, shapes, orientations, compositions, textures and moduli. These therapeutic elements may also have various compositions. For example, they may comprise various woods, plastics, rubbers or elastomers, polymeric materials (including foamed polymeric materials), and fabrics. They may be solid, hollow, or filled, may have various (or varying) densities, and may have a structure that is homogeneous or non-homogeneous across their volume. For example, in some embodiments, the therapeutic elements may comprise a polymeric material that is denser at its center than at its periphery. In other embodiments, the therapeutic elements may be filled articles featuring a fabric exterior and a particulate or granular fill (the fill may include, for example, sand, iron shot, pellets, or the like).

The devices disclosed herein may utilize various types of shafts. These shafts may be stiff, semi-flexible or flexible, and may comprise various materials. For example, these shafts may comprise rigid materials (such as, for example, wood or metal), semi-rigid materials (such as, for example, fiberglass, plastic or foam), or flexible materials (such as, for example, rope, cable, or elastomeric materials). However, the use of metal shafts is preferred, and the use of shafts comprising aluminum, titanium, aluminum alloys, titanium alloys or steel are especially preferred

The therapeutic elements in the devices and methodologies disclosed herein may be attached to an underlying shaft or substrate in various ways. Preferably, the therapeutic elements are removably attached, although embodiments are also contemplated in which the therapeutic elements are permanently attached to a shaft or substrate. By way of illustration but not limitation, the therapeutic elements may be attached to a shafts or substrate by way of one or more magnets, screws, releasably fasteners (including, for example, hook and loop type fasteners), repositionable fasteners, adhesives, mechanical couplers, press fittings, or the like.

Various end cap covers may be utilized in the devices and methodologies described herein. These end cap covers may have various sizes, shapes, orientations, compositions and stiffness, including any of those possessed by the rollers. The end cap covers may be attached to any suitable type of shaft, and by any suitable means. For example, the shaft may be stiff, semi-flexible or flexible, and the end cap covers may be releasably or permanently attached to the shaft through the use of one or more magnets, screws, releasable or repositionable fasteners, mechanical fasteners, press fittings, or the like.

In some embodiments, the bands, endcaps, and/or rollers may be removably attached to an axis or other substrate. This feature allows these elements to be removed from the device, added to other devices, or used alone.

While many of the embodiments of the therapeutic devices disclosed herein are handheld devices, it will be appreciated that embodiments are possible where these devices are affixed to a suitable substrate, such as a wall. For example, embodiments are possible where one end cap is attached to a mount, pivot or joint on, for example, a wall. Such embodiments allow the devices to be used in a gym type setting where various users of various size may wish use the device for various purposes (e.g., to manipulate various muscle groups). The ability of the device to pivot and/or to move up or down in a slot accommodates such different users and uses, while also acting as a theft deterrent. The mount, pivot or joint may be configured to provide motion only within a single plane or planes, or may permit motion along a full (e.g., 180°) or partial range of motions.

In some embodiments of the devices disclosed herein, the device may be specially configured to allow it to be taken apart readily (for example, the end cap may be readily removable from the shaft). In other embodiments, however, the device may be specifically constructed to prevent it from being taken apart or tampered with. In such embodiments, for example, the end caps may be permanently affixed to the shaft as, for example, through the use of suitable adhesives or solders, through the use of irreversible mechanical coupling devices, or by other suitable means.

As previously noted, in some embodiments, the end cap cover may be utilized to stabilize the therapeutic device against a surface. For example, the end cap cover may be utilized as a nonslip surface to maintain the therapeutic device in a particular position and/or orientation on a wall or other vertical surface while the user is using the device to manipulate particular muscle groups. In such embodiments, it is preferred that the coefficient of friction of the end cap cover surface is within the range of about 0.4 and 1.16. This may be achieved, for example, through the use of suitable materials (such as, for example, suitable grades of rubber) and/or through suitable surface texturing on the end cap cover surface.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1. A therapeutic device, comprising:
a shaft equipped with at least one spring-actuated protrusion;
a plurality of therapeutic elements rotatably mounted on said shaft, wherein each therapeutic element includes a rigid base having an elastomeric material disposed thereon; and
a first end cap which is attached to a first end of said shaft;
wherein each of said plurality of therapeutic elements contains a base with an aperture therein through which said shaft extends, and a band which extends peripherally about the surface of said base.

2. The therapeutic device of claim 1, wherein said end cap releasably engages said shaft.

3. The therapeutic device of claim 2, wherein said end cap contains a body having a frustoconical surface.

4. The therapeutic device of claim 3, wherein a surface of said body has the shape of a right frustum.

5. The therapeutic device of claim 3, wherein said body terminates on a first end thereof in a flattened surface.

6. The therapeutic device of claim 5, wherein said body terminates on a second end thereof in a threaded member which rotatingly engages a threaded aperture disposed at a first end of said shaft.

7. The therapeutic device of claim 3, further comprising a bulbous mass which releasably engages said frustoconical surface.

8. The therapeutic device of claim 7, wherein said bulbous mass comprises a resilient material.

9. The therapeutic device of claim 8, wherein said bulbous mass has a central depression on a surface thereof, wherein said central depression has a minimum diameter d₁, wherein said frustoconical surface has a maximum diameter d₂, and wherein d₂>d₁.

10. The therapeutic device of claim 1, wherein said at least one spring-actuated protrusion includes a plurality of spring-actuated protrusions which are spaced apart from each other on said shaft.

11. The therapeutic device of claim 10, wherein said therapeutic elements include first and second therapeutic elements having first and second maximum widths w₁ and w₂ in a plane which contains a longitudinal axis of said shaft and which bisects said shaft, wherein said plurality of spring-actuated protrusions includes first and second spring-actuated protrusions which are spaced apart on said shaft by a distance of d₁₂, and wherein d₁₂>(w₁+w₂).
